(19) United States
(12) Patent Application Publication
(10) Pub. No.: US 2025/0316042 A1
(43) Pub. Date: Oct. 9, 2025

(54) SYSTEMS AND METHODS FOR LIDAR POINT CLOUD PROCESSING

(71) Applicant: Nanyang Technological University, Singapore (SG)

(72) Inventors: Jianping LI, Singapore (SG); Lihua XIE, Singapore (SG); Shenghai YUAN, Singapore (SG)

(21) Appl. No.: 19/169,923

(22) Filed: Apr. 3, 2025

(30) Foreign Application Priority Data
Apr. 5, 2024 (SG) 10202401017Y

(51) Int. Cl. G06T 19/20; G01S 17/89; G06T 5/70

(52) U.S. Cl. CPC G06T 19/20; G01S 17/89; G06T 5/70; G06T 2207/10028; G06T 2210/56; G06T 2219/2016

(57) ABSTRACT

Systems and methods for LiDAR point cloud processing are disclosed that can include a point cloud data acquisition module configured to receive point cloud data, a spatial smoothing module configured to generate a fitted surface from the point cloud data using a predetermined kernel size, where the fitted surface provides an estimation of locations of points in the point cloud data, a pose adjustment module configured to perform pose adjustment on a LIDAR frame of the point cloud data by calculating an error between points on the fitted surface and corresponding data points in the point cloud data, and adjusting a pose of the LiDAR frame to minimize the error, and a convergence determination module configured to assess a convergence of the pose adjustment by comparing a change in pose adjustment to a threshold value, where if the change exceeds the threshold value, the kernel size is updated.

### CROSS REFERENCE TO RELATED APPLICATION

The present application claims priority to Singapore Application No. 10202401017Y filed on Apr. 5, 2024 with the Intellectual Property Office of Singapore, the entire disclosure of which is incorporated herein by reference.

### TECHNICAL FIELD

The present disclosure relates to 3D modeling and reconstruction. In particular, the present disclosure relates to systems and methods for constructing point clouds from LIDAR (Light Detection and Ranging) data.

### BACKGROUND

The use of LiDAR technology has become increasingly important in various applications, including autonomous vehicles, robotics, geographic information systems (GIS), and architectural and environmental modelling. LiDAR systems generate point clouds by emitting laser pulses and measuring the time it takes for the pulses to reflect off surfaces and return to the sensor. These point clouds may provide highly detailed 3D representations of the scanned environment.

However, achieving accurate and consistent point clouds remains a challenging task due to several factors. First, the raw LiDAR data is often noisy and contains measurement errors, leading to inaccuracies in the resulting point clouds. Second, the pose (position and orientation) of the LiDAR sensor may vary over time, introducing inconsistencies in the data. Third, existing methods for processing LiDAR data often focus on either local consistency or global accuracy but may struggle to achieve both simultaneously.

Therefore, in order to address or alleviate at least one of the aforementioned problems and/or disadvantages, there is a need to provide an improved system and method for constructing point clouds from LIDAR data.

### SUMMARY OF THE INVENTION

According to a first aspect of the present disclosure a system for LiDAR point cloud processing is provided. The system comprises a point cloud data acquisition module configured to receive point cloud data; a spatial smoothing module configured to generate a fitted surface from the point cloud data using a predetermined kernel size, wherein the fitted surface provides an estimation of locations of points in the point cloud data; a pose adjustment module configured to perform pose adjustment on a LIDAR frame of the point cloud data by calculating an error between points on the fitted surface and corresponding data points in the point cloud data, and adjusting a pose of the LIDAR frame to minimize the error; and a convergence determination module configured to assess a convergence of the pose adjustment by comparing a change in pose adjustment to a threshold value, wherein if the change exceeds the threshold value, the kernel size is updated, and the system is configured to repeat the spatial smoothing and pose adjustment modules with the updated kernel size.

In an embodiment, the spatial smoothing module is further configured to sample the point cloud data using Principal Component Analysis (PCA) to calculate an initial point normal of the point cloud data.

In an embodiment, the spatial smoothing module is further configured to obtain an estimation of initial point normals in relation to neighborhood point normals, wherein neighborhood points are located within a distance defined by the kernel size from the initial points.

In an embodiment, the spatial smoothing module is further configured to project neighborhood points to a tangent space of a kernel.

In an embodiment, the spatial smoothing module is further configured to determine parameters for a kernel using the projected neighborhood points.

In an embodiment, the spatial smoothing module is further configured to determine optimal parameters for a polynomial smoothing kernel using least squares estimation, wherein the estimation is based on a Gaussian radial weight function.

In an embodiment, the pose adjustment module is further configured to determine a Jacobian of the error.

In an embodiment, the convergence determination module is configured to update the kernel size by reducing the kernel size.

In an embodiment, the convergence determination module is configured to update the kernel size by reducing the kernel size in steps according to a predefined reduction factor or a reduction function.

In an embodiment, the convergence determination module is configured to update the kernel size with a constant.

In an embodiment, the system further comprises an output module configured to output a smoothed point cloud calculated from the fitted surface generated from the spatial smoothing module.

According to a second aspect of the present disclosure a method for LiDAR point cloud processing is provided. The method comprises the steps of receiving point cloud data; generating a fitted surface from the point cloud data using a predetermined kernel size, wherein the fitted surface provides an estimation of the locations of points in the point cloud data; performing pose adjustment on a LIDAR frame of the point cloud data by calculating an error between points on the fitted surface and corresponding data points in the point cloud data, and adjusting a pose of the LiDAR frame to minimize the error; assessing a convergence of the pose adjustment by comparing a change in pose adjustment to a threshold value; and when the change exceeds the threshold value, updating the kernel size and re-iterating the fitted surface generation and pose adjustment steps with the updated kernel size.

In an embodiment, the step of generating the fitted surface further comprises sampling the point cloud data using Principal Component Analysis (PCA) to calculate an initial point normal of the point cloud data.

In an embodiment, the step of generating the fitted surface further comprises obtaining an estimation of initial point normals in relation to neighborhood point normals, wherein neighborhood points are located within a distance defined by the kernel size from the initial points.

In an embodiment, the step of generating the fitted surface further comprises projecting neighborhood points to a tangent space of a kernel.

In and embodiment, the step of generating the fitted surface further comprises determining parameters for a kernel using the projected neighborhood points.

In an embodiment, the step of generating the fitted surface further comprises determining optimal parameters for a polynomial smoothing kernel using least squares estimation, wherein the estimation is based on a Gaussian radial weight function.

In an embodiment, the step of performing pose adjustment further comprises determining a Jacobian of the error between points on the fitted surface and corresponding data points in the point cloud data.

In an embodiment, the step of assessing convergence of the pose adjustment further comprises updating the kernel size by reducing the kernel size.

In an embodiment, the step of assessing convergence of the pose adjustment further comprises updating the kernel size by reducing the kernel size in steps according to a predefined reduction factor or a reduction function.

In an embodiment, the step of assessing convergence of the pose adjustment further comprises updating the kernel size with a constant.

In an embodiment, the method further comprises outputting a smoothed point cloud calculated from the fitted surface generated from the spatial smoothing module.

According to a third aspect of the present disclosure a computer readable medium is provided. The computer readable medium comprises processor executable instructions operable to cause a processor to carry out a method according to any of the preceding aspects or embodiments.

According to a fourth aspect of the present disclosure, a data processing system for LIDAR point cloud processing is provided. The data processing system comprises a processor, and program storage, the program storage storing computer program instructions operative by the processor to: generate a fitted surface from the point cloud data using a predetermined kernel size, wherein the fitted surface provides an estimation of the locations of points in the point cloud data; perform pose adjustment on a LiDAR frame of the point cloud data by calculating an error between points on the fitted surface and corresponding data points in the point cloud data, and adjusting a pose of the LiDAR frame to minimize the error; assess a convergence of the pose adjustment by comparing a change in pose adjustment to a threshold value; and when the change exceeds the threshold value, update the kernel size and re-iterate the fitted surface generation and pose adjustment steps with the updated kernel size.

Any one of the above aspects or embodiments may be combined with one or more further aspects or embodiments.

In an embodiment the second third, or fourth aspects of the present disclosure are combined with any of the embodiments described in the first aspect of the present disclosure.

A point cloud generation system and method according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

In the following, embodiments of the present invention will be described as non-limiting examples with reference to the accompanying drawings in which:

FIG. 1A illustrates an example of pose adjustment;

FIG. 1B illustrates an example of point cloud smoothing;

FIG. 1C and FIG. 1D illustrate examples of multiview point cloud registration

FIG. 1E illustrate an example of identification of points, lines and planes using LiDAR systems;

FIG. 1F and FIG. 1G illustrate examples of point cloud smoothing;

FIG. 2 illustrates an example embodiment of a system for LiDAR point cloud processing;

FIG. 3 illustrates an example process of a method for LiDAR point cloud processing;

FIG. 4 illustrates an example of LiDAR bundle adjustment with progressive spatial smoothing;

FIG. 5 illustrates an example system overview of LiDAR bundle adjustment with progressive spatial smoothing (PSS-BA);

FIG. 6 illustrates an example of surface fitting within a smoothing kernel;

FIG. 7 illustrates an example simulation of UAV LiDAR sensing in complex environments using MARSIM;

FIG. 8A-8D illustrates results of an evaluation of different methods on 4 different simulation datasets;

FIG. 9 illustrates a visual comparison of results according to example embodiments as disclosed herein;

FIG. 10 illustrates an example embodiment of a mapping system;

FIG. 11 illustrates an example of sample point clouds resulting from PSS-BA according to an embodiment;

FIG. 12 illustrates results of an evaluation of different methods on a dataset.

### DETAILED DESCRIPTION

For purposes of brevity and clarity, descriptions of embodiments of the present disclosure are directed to a in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organisation of elements that mathematically exhibits a cardinality of at least one (e.g. a set as defined herein can correspond to a unit, singlet, or single-element set, or a multiple-element set), in accordance with known mathematical definitions. The terms “first”, “second”, etc. are used merely as labels or identifiers and are not intended to impose numerical requirements on their associated terms.

As used in the present disclosure, the terms “component”, “module”, “system”, “interface” and the like are generally intended to refer to a computer-related entity, either hardware, a combination of hardware and software, software, or software in execution. For example, a module may be, but is not limited to being, a process running on a processor, a processor, an object, an executable, a thread of execution, a program, and/or a computer. By way of illustration, both an application running on a controller and the controller can be a component. One or more modules may reside within a process and/or thread of execution and a module may be localized on one computer and/or distributed between two or more computers. As another example, an interface can include I/O components as well as associated processor, application, and/or API components. In the context of the present disclosure, the information processing and response generation system and its constituent parts may be implemented as hardware, software, or a combination thereof.

Furthermore, various embodiments of the present disclosure may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.).

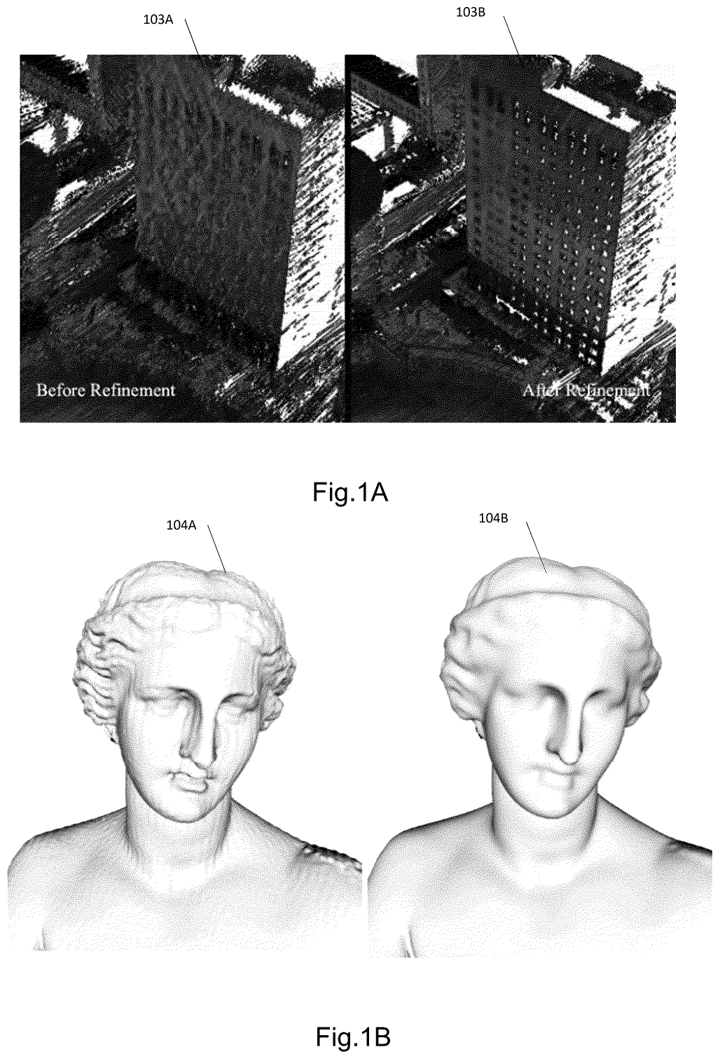

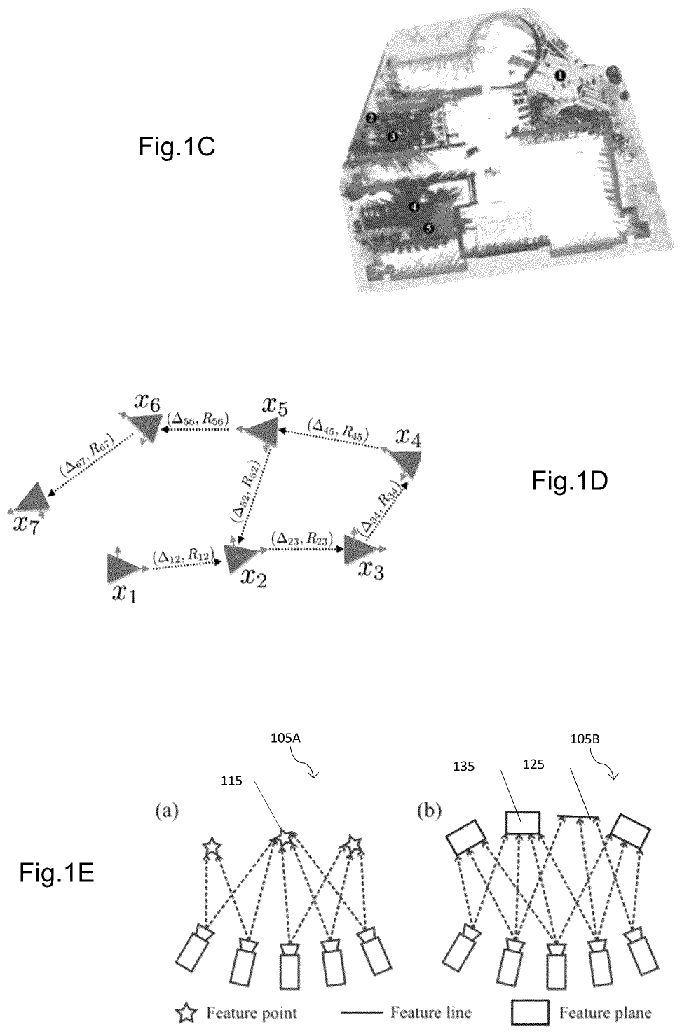

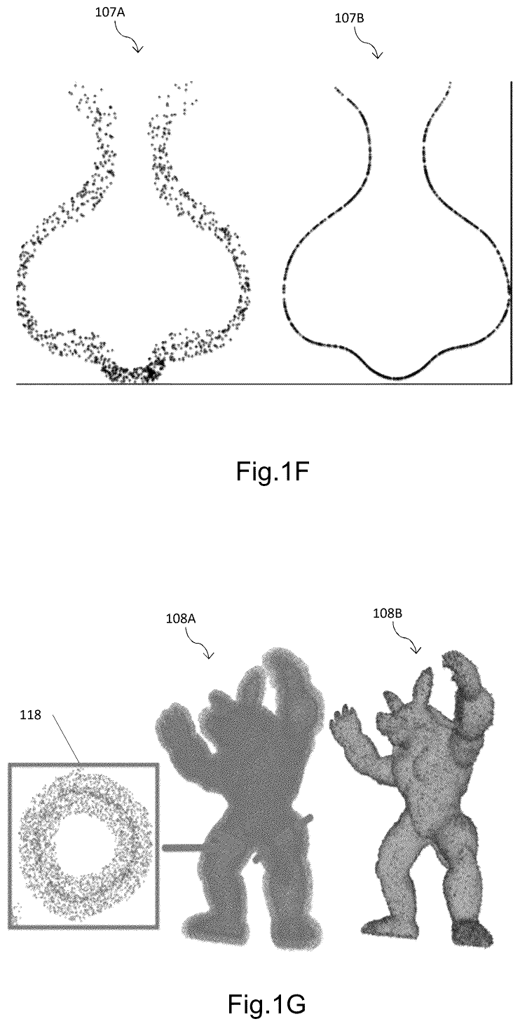

FIG. 1A illustrates an example of pose adjustment of a building reconstruction using LIDAR data, which may comprise the pose adjustment as described herein. Building reconstruction 103A in the left image is a reconstruction before a pose adjustment, and building reconstruction 103B in the right image is a reconstruction after a pose adjustment. As is evident, the reconstruction 103B provides a sharper image as a result of the pose adjustment.

FIG. 1B illustrates an example of point cloud smoothing of a statue reconstruction using LiDAR data, which may comprise the point cloud smoothing as described herein. Statue reconstruction 104A in the left image is a reconstruction before a point cloud smooth process, and statue reconstruction 104B in the right image is a reconstruction after a point cloud smoothing process. As is evident, the reconstruction 104B provides a smoother image.

FIGS. 1C and 1D illustrate an example of multiview point cloud registration, and a problem that may arise where information within point cloud data is not fully utilised. These figures show that in point cloud registration/construction from raw data, not all information from the raw data may be fully utilised.

FIG. 1E illustrates an example of the difficulty in finding edges or plane factors in complex environments with LiDAR systems. Image 105A on the left illustrates the identification of points 115, and Image 105B on the right illustrates the identification of lines 125 or planes 135.

FIG. 1F illustrates an example of point cloud smoothing. The left image reconstruction 107A comprises multiple LiDAR datapoints forming the reconstruction, but is evidently noisy as the data points are spread. The right image reconstruction 107B comprises smoothed LiDAR points, which are fit to a plane or kernel as described herein.

FIG. 1G illustrates an example of point cloud smoothing. The left image reconstruction 108A comprises LiDAR datapoints forming the image, and as inset at 118, are spread and therefore result in a noisy image. The right image reconstruction 108B comprises smoothed datapoints and therefore results in a smoother image reconstruction. Existing systems and methods for generating point clouds may encounter several challenges. Firstly, raw LiDAR data may be noisy and contain measurement errors, which can lead to inaccuracies in resulting point clouds. Secondly, the pose (position and orientation) of a LIDAR sensor may vary over time, introducing inconsistencies in the data. Thirdly, existing methods for processing LiDAR data often focus on either local consistency or global accuracy but may not be able to achieve both simultaneously. The present invention addresses these challenges by introducing a method and system for constructing point clouds from LiDAR scanning data that combines a spatial smoothing module and a pose adjustment module. The spatial smoothing module may enhance local consistency by applying a progressive smoothing algorithm that iteratively refines the LiDAR data. The pose adjustment module may improve global accuracy by minimizing pose errors and adjusting the poses based on optimization results. By integrating these modules, example embodiments as described herein may provide a comprehensive solution for generating accurate and consistent point clouds, thereby improving the quality and reliability of 3D models.

Accurate and consistent construction of point clouds from LiDAR scanning data is fundamental for 3D modelling applications. Current solutions, such as multiview point cloud registration and LiDAR bundle adjustment, predominantly depend on a local plane assumption, which may be inadequate in complex environments lacking of planar geometries or substantial initial pose errors.

To mitigate this problem, example embodiments described herein may comprise LiDAR bundle adjustment with progressive spatial smoothing, which may be suitable for complex environments and exhibit improved convergence capabilities.

Systems and methods as disclosed herein may comprise a spatial smoothing module and a pose adjustment module, which may combine the benefits of local consistency and global accuracy. For example, the spatial smoothing module may allow generation of robust and rich surface constraints employing smoothing kernels across various scales. Additionally, the pose adjustment module may correct all poses utilizing these surface constraints. Accordingly, example embodiments disclosed herein may simultaneously achieve fine poses and parametric surfaces that can be directly employed for high-quality point cloud reconstruction. The effectiveness and robustness of the proposed approach is validated on both simulation and real-world datasets as described herein. The experimental results detailed below demonstrate that the proposed approach may outperform existing methods and achieve better accuracy in complex environments with low planar structures.

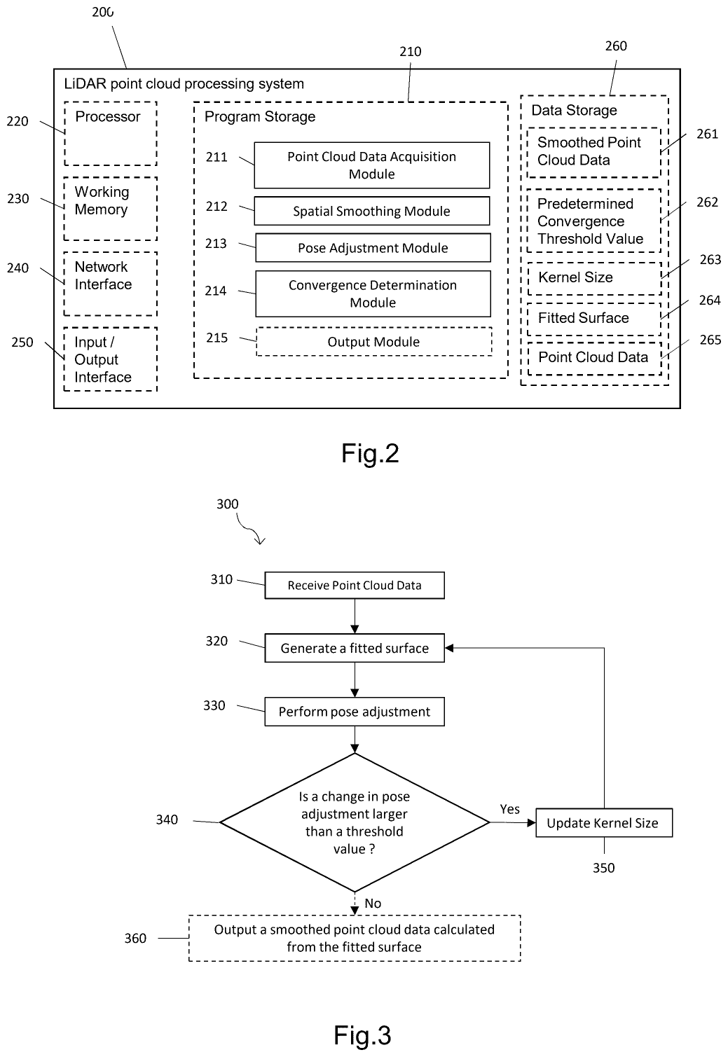

FIG. 2 is a block diagram 200 showing a system for LiDAR point cloud processing according to an example embodiment of the present invention, with dashed lines showing potential embodiments of the present invention.

The system 200 comprises a point cloud data acquisition module 211 configured to receive point cloud data 265. The point cloud data may be data from noisy point clouds captured by a laser scanner. The laser scanner may be a light-weight solid state type that collect sparse LiDAR frames. In an example embodiment for real-life data collection, the laser scanner may be mounted to an Unmanned Aerial Vehicle (UAV) or a wearable device on human body.

The system 200 further comprises a spatial smoothing module 212 configured to generate a fitted surface 264 from the point cloud data 265 using a predetermined kernel size 263, wherein the fitted surface 264 provides an estimation of locations of points in the point cloud data 265.

As a part of the process to generate the fitted surface 264, the spatial smoothing module 212 may be configured to engage a sampling method to reduce the number of points in the point cloud while preserving the structure and/or key features of the data. For this purpose, the spatial smoothing module may be configured to sample the point cloud data using Principal Component Analysis (PCA) to calculate an initial point normal of the point cloud data.

Additionally, the spatial smoothing module 212 may also be configured to obtain an estimation of initial point normals in relation to neighborhood point normals, wherein neighborhood points are located within a distance defined by the kernel size 263 from the initial points. This embodiment assumes a continuous 3D environment with minimal variation in the normals across a local space.

In one embodiment of the spatial smoothing module 212, after sampling with a kernel of predetermined size, wherein neighborhood points are identified within a distance defined by the kernel size 263 from the initial points, the spatial smoothing module 212 is further configured to project these neighborhood points to a tangent space of a kernel. The module may then determine parameters for the kernel using the projected neighborhood points. These parameters serve as defining features for the function that characterizes the fitted surface generated by the spatial smoothing module.

In complex environments, the fitted surface may rely on planar features and may not provide sufficiently accurate representation of the point cloud data for subsequent pose adjustment. Accordingly, smoothing may be carried out as described herein.

In one embodiment, the spatial smoothing module 212 may use a polynomial smoothing kernel and generate a polynomial fitted surface. The adoption of a polynomial smoothing kernel may enable the capturing of general feature correspondences and relatively more accurate processing of point cloud data 265 of a complex environment.

In this embodiment, the spatial smoothing module 212 may determine optimal parameters for a polynomial smoothing kernel using least squares estimation, wherein the estimation is based on a Gaussian radial weight function. A Gaussian radial weight function assigns higher weights to projected neighborhood points that are closer to the center and progressively lower weights to those farther away, ensuring that nearby points exert a stronger influence on the fitted surface 264. This approach not only enhances the surface's local adaptability but also reduces the impact of noise. Alternatively, the Gaussian radial weight function in this embodiment may be replaced with other weighting functions that achieve a similar effect on the fitted surface 264.

The system 200 further comprises a pose adjustment module 213 configured to perform pose adjustment on a LiDAR frame of the point cloud data by calculating an error between points on the fitted surface 264 and corresponding data points in the point cloud data 265, and adjusting a pose of the LiDAR frame to minimize the error.

The fitted surface 264 used for error calculation may be a polynomial fitted surface. Unlike a planar surface, a polynomial fitted surface captures more general features, making it more effective in complex environments that lack structural features. This fitted surface 264 may serve as a constraint passed from the spatial smoothing module 212 to the pose adjustment module 213.

In example embodiments utilizing a polynomial fitted surface, the extracted polynomial coefficients may also be referred to as constraints being passed from the spatial smoothing module 212 to the pose adjustment module 213.

In an embodiment, the pose adjustment module 213 is further configured to determine a Jacobian of the error. The Jacobian represents how small variations in the pose adjustment parameter affect the error. Other mathematical operations to the same effect may apply.

Post adjustment 213 may also be referred to as LiDAR bundle adjustment or pose correction.

The system 200 further comprises a convergence determination module 214 configured to assess a convergence of the pose adjustment by comparing a change in pose adjustment to a threshold value 262, wherein if the change exceeds the threshold value, the kernel size 263 is updated, and the system is configured to repeat the spatial smoothing 212 and pose adjustment modules 213 with the updated kernel size 263. In one embodiment, the kernel size 263 is updated by reducing the kernel size. The kernel size 263 may be updated by reducing the kernel size in steps according to a predefined reduction factor or a reduction function. The kernel size 263 may also be updated with a constant. A progressive reduction of kernel size 263, combines with iterative spatial smoothing using the finer kernel size, improves the convergence and accuracy of the post adjustment.

In the spatial smoothing module 212, an estimation of the point locations in the point cloud data may be represented by a smoothed point cloud 261 derived from the fitted surface 264 and the system 200 may be configured to output either the constructed smoothed point cloud or the fitted surface for use in 3D modeling applications, such as Building Information Modeling (BIM). Accordingly, the system 200 may further comprises an output module 215 configured to output a smoothed point cloud 261 calculated from the fitted surface 264 generated from the spatial smoothing module 212. In an example embodiment, a data processing system for LiDAR point cloud processing may comprise a processor 220, and program storage 260, the program storage 210 storing computer program instructions operative by the processor to carry out one or more of the steps as described herein. For example, to generate a fitted surface from the point cloud data using a predetermined kernel size, wherein the fitted surface provides an estimation of the locations of points in the point cloud data; to perform pose adjustment on data LiDAR frame by calculating an error between points on the fitted surface and corresponding data points in the point cloud data, and adjusting a pose of the LiDAR frame to minimize the error; to assess a convergence of the pose adjustment by comparing a change in pose adjustment to a threshold value; and when the change exceeds the threshold value, to update the kernel size and re-iterate the fitted surface generation and pose adjustment steps with the updated kernel size.

The program storage 210 may further store computer program instructions operative by the processor 220 to output a smoothed point cloud 261 calculated from the generated fitted surface 264.

The data processing system 200 may further comprise modules of working memory 230, a network interface 240, and an input/output interface 250 to facilitate communication and data exchange with users or other devices. Additionally, the data processing system may include a data storage module for storing smoothed point cloud data 261, a predetermined convergence threshold value 262, kernel size 263 values for each iteration of the program, fitted surface 264 and/or point cloud data 265 as described herein.

FIG. 3 is a flowchart 300 showing a method for LiDAR point cloud processing according to an example embodiment of the present invention, with dashed lines showing potential embodiments of the present invention.

The method comprises a step of receiving point cloud data 310. The point cloud data may be data from noisy point clouds captured by a laser scanner. The laser scanner may be a light-weight solid state type that collect sparse LiDAR frames. In an example embodiment for real-life data collection, the laser scanner may be mounted to an Unmanned Aerial Vehicle (UAV) or a wearable device on human body.

The method further comprises a step of generating a fitted surface 320 from the point cloud data using a predetermined kernel size, wherein the fitted surface provides an estimation of the locations of points in the point cloud data; In an embodiment, the step of generating the fitted surface 320 may further comprise sampling the point cloud data using Principal Component Analysis (PCA) to calculate an initial point normal of the point cloud data. The sampling step may reduce the number of points in the point cloud while preserving the structure and key features of the data.

In an embodiment, the step of generating the fitted surface 320 may further comprise obtaining an estimation of initial point normals in relation to neighborhood point normals, wherein neighborhood points are located within a distance defined by the kernel size from the initial points. This embodiment assumes a continuous 3D environment with minimal variation in the normals across a local space.

In an embodiment, the step of generating the fitted surface 320 may further comprise projecting neighborhood points, defined as points located within a distance defined by the kernel size from the initial points in the previous embodiment, to a tangent space of a kernel. An additional step may be determining parameters for the kernel using the projected neighborhood points. These parameters serve as defining features for the function that characterizes the generated fitted surface.

In an embodiment, the step of generating the fitted surface 320 may further comprise determining optimal parameters for a polynomial smoothing kernel using least squares estimation, wherein the estimation is based on a Gaussian radial weight function. Using a polynomial smoothing kernel to generate a polynomial fitted surface provides improved accuracy by capturing general features in complex environments better than planar-based fitted surfaces. The use of a Gaussian radial weight function reduces the impact of noise in the data and the function may be replaced with any other weighting function that achieves a similar effect on the fitted surface.

The method further comprises a step of performing pose adjustment 330 on a LIDAR frame of the point cloud data by calculating an error between points on the fitted surface and corresponding data points in the point cloud data, and adjusting a pose of the LIDAR frame to minimize the error. The fitted surface used for error calculation may be a polynomial fitted surface. The fitted surface may be referred to as a constraint for the pose adjustment step 330. The extracted polynomial coefficients may also be referred to as constraints for the pose adjustment step 330.

In an embodiment, the step of performing pose adjustment may further comprise determining a Jacobian of the error between points on the fitted surface and corresponding data points in the point cloud data. The Jacobian represents how small variations in the pose adjustment parameter affect the error. Other mathematical operations to the same effect may apply.

The method 300 further comprises a step of assessing a convergence of the pose adjustment 340 by comparing a change in pose adjustment to a threshold value; and when the change exceeds the threshold value, updating the kernel size 350 and re-iterating the fitted surface generation 320 and pose adjustment steps 330 with the updated kernel size.

In an embodiment, the step of assessing convergence of the pose adjustment 340 may further comprise updating the kernel size by reducing the kernel size.

In an embodiment, the step of assessing convergence of the pose adjustment 340 may further comprise updating the kernel size by reducing the kernel size in steps according to a predefined reduction factor or a reduction function.

A progressive reduction of kernel size, combined with iterative spatial smoothing using a finer kernel size, may improve the convergence and accuracy of the post adjustment.

In an embodiment, the step of assessing convergence of the pose adjustment 340 may further comprise updating the kernel size with a constant.

In an embodiment, the method further comprises outputting a smoothed point cloud 360 calculated from the fitted surface generated from the spatial smoothing module.

Alternatively, the method may comprise outputting the fitted surface for use in 3D modeling applications, such as Building Information Modeling (BIM).

Accurate 3D reconstruction of in GNSS-denied complex environment is a fundamental task in the fields of photogrammetry and robotics, in which exported point clouds are the basis for many tasks such as facility inspection, building information modelling (BIM), and robot navigation. Although commercial mobile mapping systems equipped with expensive sensors have shown powerful mapping ability over the past decade, with recent developments in light-weight solid LiDAR technologies, research on improving the quality of point cloud collected by low-cost mapping systems is ongoing in both academia and industry.

In general, point cloud data obtained from a mobile mapping system are subjected to two sources of error: the pose error and the LiDAR measurement error. Most existing SLAM systems utilize some sequential registration scheme (e.g., ICP, NDT, features) to merge the laser scans together, where the incremental processing may cause accumulated error in the pose estimates. The pose error can be corrected using some LIDAR bundle adjustment method (which is discussed below in Section A). As for the LIDAR measurement error, this is mainly caused by range measurement noise, which can be corrected using point cloud smoothing or map-centric optimization in 3D space (this is discussed in more detail in Section B below).

In example embodiments, it has been determined that the LiDAR bundle adjustment and point cloud smoothing processes can benefit each other. On one hand, even with the imperfect initial poses, the local shape prior of the noisy point clouds can still be recognized by applying smoothing kernels in 3D space. The shape prior can be used as a more general factor in bundle adjustment than the planar features. On the other hand, the adjusted poses may guarantee the global accuracy of the point clouds compared to only conducting point cloud smoothing in a local 3D space. The related works of LiDAR bundle adjustment and point cloud smoothing are reviewed as follows.

### A. LIDAR Bundle Adjustment

Bundle adjustment, a fundamental technique originating from photogrammetry, aims to simultaneously estimate sensor poses and 3D feature coordinates in world frames. This process is facilitated by extracting 2D point correspondences through image point features, hence enabling bundle adjustment factors via reprojection error. Conversely, in LiDAR bundle adjustment, the primary objective remains the estimation of all sensor poses. However, the inherent sparsity of point clouds in LiDAR data presents significant challenges in identifying precise point-level correspondences between frames. A concise and simple point-to-point correspondence is usually very hard to construct for pose correction in the LiDAR bundle adjustment task. Therefore, the core issue of LIDAR bundle adjustment lies in the proper design and extraction of correspondences and factors.

LiDAR bundle adjustment can be regarded as an extension of pair-wise point cloud registration. Prior examples include conducting pair-wise registration between all scanning data with overlaps, then the relative transformations may be synchronized using a pose graph with outlier rejection. These methods may operate for dense point clouds collected by terrestrial laser scanner and close-range structure-light scanner. However, the sparse LiDAR frames collected by light-weight solid-state laser scanners face great challenges obtaining accurate registration using existing point cloud registration algorithms. Moreover, the pose graph only considers relative transforms from pair-wise registration, loses information from raw point clouds, and restricts the mapping accuracies.

Some examples in the field of robotics include the extraction of planar features from initial noisy point clouds, followed by conducting bundle adjustment utilizing these planar constraints. These methods may be implemented in SLAM and sensor calibration. However, their reliance on planar features can lead to performance degradation and divergence in complex environments that lack structural features. Consequently, the applicability of existing planar feature-based LiDAR bundle adjustment methods is restricted, particularly in constructing BIM for complex buildings. Accordingly, example embodiments as disclosed herein may extract more general feature correspondences using polynomial surface kernels with different scales to provide convergence and accuracy. Moreover, example embodiments may analytically derive the Jacobian of the polynomial residual with respect to the poses to speed up the optimization.

### B. Point Cloud Smoothing

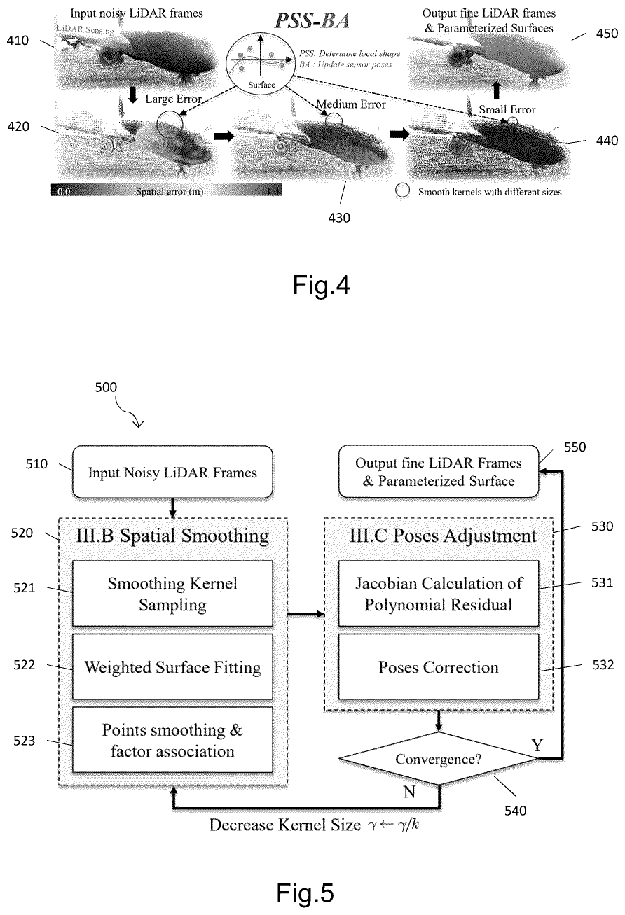

Point cloud smoothing and map-centric optimization improve the point cloud quality in the aspect of spatial consistency without considering the sensor poses, which are different from the existing LiDAR bundle adjustment that only optimizes the sensor poses. More specifically, the core assumption of most existing point cloud smoothing methods is the continuity and smoothness of the environments. The moving least squares (MLS) and its variations are widely used for rendering and filtering of point clouds. MLS-based methods first determine the local shape using polynomial smooth kernels, then project the nearby points onto the fitted surface. With the fitting and projecting procedure, the point clouds are smoothed and the qualities are improved. However, as the point cloud smoothing methods only maintain the local consistency of the point clouds, the pose drifts will not be corrected during the smoothing processing, and they cannot provide global accuracy, especially for indoor mapping applications. Thus, example embodiments as disclosed herein may combine the point cloud smoothing with bundle adjustment, and also correct the poses when conducting spatial smoothing to provide global accuracy of the point clouds. Moreover, fixing the kernel size of existing point cloud smoothing methods may suffer from overfitting or underfitting of the local shape. Example embodiments may therefore progressively conduct spatial smoothing with different kernel sizes to achieve the convergence of the optimization. Overall, to tackle the challenges of existing LiDAR bundle adjustment methods in complex environments, example embodiments as disclosed herein comprise bundle adjustment and progressive spatial smoothing (PSS-BA). As shown in FIG. 4, a core concept of the proposed PSS-BA is that, even with imperfect initial poses, example embodiments can obtain a shape prior by applying multi-scale smooth kernels on the initial noisy point clouds. Then, the multi-scale smooth kernels may be used for pose correction progressively.

FIG. 4 illustrates an example of LiDAR bundle adjustment with progressive spatial smoothing. In the example, noisy LiDAR frames 410 are taken as input and PSS-BA progressively smooths out the noisy data and updates LiDAR poses, which provides both the convergence and accuracy of state estimation. The spatial error gradually decreases through application of the PSS-BA 410, 430, 440. PSS-BA enables the simultaneous generation of accurate LiDAR frames and parameterized surfaces 450 and facilitates 3D modelling.

Example embodiments may provide one or more of the following advantages:
PSS-BA may utilize the surface smooth kernel for constructing BA residuals, which may provide more robust and richer constraints in complex environments compared to existing BA methods based on planar constraints.
PSS-BA may introduce progressive smoothing to accelerate BA convergence and improve accuracy compared to setting a fixed scale.
PSS-BA may simultaneously achieve fine poses and parametric surfaces that can be directly employed for high-quality point cloud reconstruction and 3D modelling applications such as BIM.

Section II below provides a description of a proposed method as an example embodiment. Section III provides details of experiments conducted on simulation and in-house datasets according to example embodiments. Section IV provides conclusion and future work input.

### A. Notations and System Overview

1) Poses: As used herein, italic, bold lowercase, and bold uppercase letters are used to represent scalars, vectors, and matrices, respectively. Three main frames of reference are used in the example embodiments, namely, the world frame F^{W}, the LiDAR frame F^{L}, and the tangent frame F^{S} defined in a local 3D space. Example embodiments denote any point observed by the LiDAR in the i-th frame as pᵢ^{L}. The pose for the i-th LiDAR frame is denoted as [Rᵢ, tᵢ], where Rᵢ∈SO(3) is the rotation matrix, tᵢ∈ [symbol] ³ is the translation vector. All the poses are denoted as X={[Rᵢ, tᵢ], i=0, 1, . . . }. The initial value is noted with breve ŏ, and the estimated value is noted with the hat ô. The estimated pose for the i^{th} LiDAR frame is denoted as [\hat{R}ᵢ=Exp(Δθi)R, \hat{t}ᵢ=Δtᵢ+tᵢ], where Δθᵢ∈ [symbol] ³ and Δₜᵢ∈ [symbol] ³ are the corresponding errors. The exponential map Exp: [symbol] ³→SO(3) has the form:

$$Exp ( Δ {θ}_{i} ) = I + {\frac{sin ( \vert Δ {θ}_{i} \vert )}{\vert Δ {θ}_{i} \vert} [ Δ {θ}_{i} ]}_{\times } + {\frac{1 - cos ( \vert Δ {θ}_{i} \vert )}{{\vert Δ {θ}_{i} \vert}^{2}} [ Δ {θ}_{i} ]}_{\times }^{2} \qquad ( 1 )$$

The point

$${\hat{p}}_{i}^{W} .$$

in the world frame F^{W} could be obtained using (2).

$${\hat{n}}_{i} \approx {n}_{i} + [ {\hat{n}}_{i}^{0} , {\hat{n}}_{i}^{1} ] Δ {ϕ}_{i} , \qquad ( 2 )$$

2) 3D Normal: For the initial inaccurate normal \hat{n}ᵢ associated with

$${\hat{p}}_{i}^{W}$$

it satisfies |\hat{n}|=1. Thus, the normal vector's degree of freedom is two, and it can be rewritten as:

$${\hat{n}}_{i} \approx {n}_{i} + [ {\hat{n}}_{i}^{0} , {\hat{n}}_{i}^{1} ] Δ {ϕ}_{i} , \qquad ( 3 )$$

where Δϕᵢ with shape of 2×1 represents the small errors. The vectors

$${\hat{n}}_{i}^{0} , {\hat{n}}_{i}^{1}$$

are two unit vectors and orthogonal to both \hat{n}ᵢ and each other.

3) Polynomial Smoothing Kernel: For a second-order polynomial surface defined within a local tangent space F^{S}, its functional form is as follows:

$$z = f ( x , y ) = {{α}^{T} [ {x}^{2} , {y}^{2} , xy , x , y ]}^{T} , \qquad ( 4 )$$

where the vector α with shape of 5×1 represents the coefficients that describe the surface's shape. Assuming a continuous 3D environment, the point clouds within the local tangent space are projected onto the surface f to mitigate measurement noise.

4) System Overview: Example embodiments include two modules, namely spatial smoothing (II-B) and poses adjustment (II-C), which are illustrated in FIG. 5.

FIG. 5 illustrates an example system overview of LiDAR bundle adjustment with progressive spatial smoothing (PSS-BA) 500. In the example embodiment, noisy LiDAR frames 510 are input into a spatial smoothing module 520, which may comprise a smoothing kernel sampling module 521, a weighted surface fitting module 522 and a points smoothing and factor association module 523. The spatial smoothing module 520 may then output a constraint to a pose adjustment module 530, which may comprise a Jacobian calculation of polynomial residual module 541 and a poses correction module 532. Subsequently in this example, the convergence 540 of the pose adjustment is assessed, wherein the spatial smoothing module 520 and the poses adjustment module 530 are iterated with a decreased kernel size if convergence 540 is not achieved. Otherwise if convergence 540 is achieved, fine LiDAR frames and parameterized surface is outputted 550.

In an example embodiment, taking noisy LiDAR frames as input, and a preset large smoothing kernel width γ, the spatial smoothing module, such as that disclosed herein, may smooth the noisy point cloud at a coarse scale and obtain polynomial coefficients. Then the pose adjustment module, such as that disclosed herein, may utilize the extracted polynomial coefficients to correct the LiDAR frames. If the change of correction is smaller than a threshold, it could be regarded as convergence. Otherwise, the smoothing kernel width γ may be decreased to a finer scale γ←γ/k to conduct the spatial smoothing again. The iterative smoothing and adjustment strategy may provide for the convergence and accuracy of the LiDAR bundle adjustment as described herein.

### B. Spatial Smoothing for LiDAR Factor Extraction

1) Smoothing Kernel Sampling: In example embodiments, input noisy point clouds may be uniformly sampled using the voxel size of γ. Afterwards, the remaining points,

$$\{ {\hat{p}}_{i}^{W} , i ∈ Ψ \} ,$$

may be treated as smoothing kernels. The initial point normals for each point in the noisy point clouds may be calculated using Principal Component Analysis (PCA). For a given smoothing kernel,

$${\hat{p}}_{i}^{W} ,$$

example embodiments may define its neighbouring points within the distance of γ as

$$\{ {\hat{p}}_{j}^{W} , j ∈ {Φ}_{j} \} .$$

The initial point normals for the smoothing kernel

$${\hat{p}}_{i}^{W}$$

and a neighborhood

$${\hat{p}}_{j}^{W}$$

may be respectively defined as n̆ᵢ and n̆ⱼ.

Under the assumption of a continuous 3D environment, there is minimal variation in the normals across a local space. Consequently, example embodiments can obtain an optimal estimation of the normal, denoted as \hat{n}ᵢ for the smoothing kernal

$${\hat{p}}_{i}^{W}$$

by solving the objective function G(\hat{n}ᵢ) that constrains the change of normals respect to neighbourhood normals:

$${arg min}_{{\hat{n}}_{i} , \vert {\hat{n}}_{i} \vert = 1} G ( {\hat{n}}_{i} ) = 1 - {\hat{n}}_{i}^{T} {\breve{n}}_{i} + μ {\vert D ( {\hat{n}}_{i} ) \vert}_{0} , \\ {D ( {\hat{n}}_{i} )}_{j} = 1 - {\hat{n}}_{i}^{T} {\breve{n}}_{j} , \qquad ( 5 )$$

where D(\hat{n}ᵢ) is the differential function for \hat{n}ᵢ in the 3D space. In example embodiments, the L₀ normalization counting the non-zero item may be used here to eliminate the influence of outliers and preserve the original shape in the sharp regions. μ is the weight that balances the data term and smooth term. Equation (5) can be minimized using an auxiliary function and is detailed in the appendix.

In example embodiments, when the optimal normal \hat{n}ᵢ for the smoothing kernel

$${\hat{p}}_{i}^{W}$$

is obtained, the local tangent frame F^{S} may be established for

$${\hat{p}}_{i}^{W}$$

by constructing three orthogonal axes:

$${\hat{n}}_{2}^{i} = {\hat{n}}_{i} , {\hat{n}}_{1}^{i} = {[ {\hat{n}}_{i , 1} , - {\hat{n}}_{i , 0} , 0 ]}^{T} , {\hat{n}}_{0}^{i} = {\hat{n}}_{1}^{i} \times {\hat{n}}_{i} . \qquad ( 6 )$$

With these three axes,

$${\hat{M}}_{i} = {[ {\hat{n}}_{0}^{i} , {\hat{n}}_{1}^{i} , {\hat{n}}_{2}^{i} ]}^{T}$$

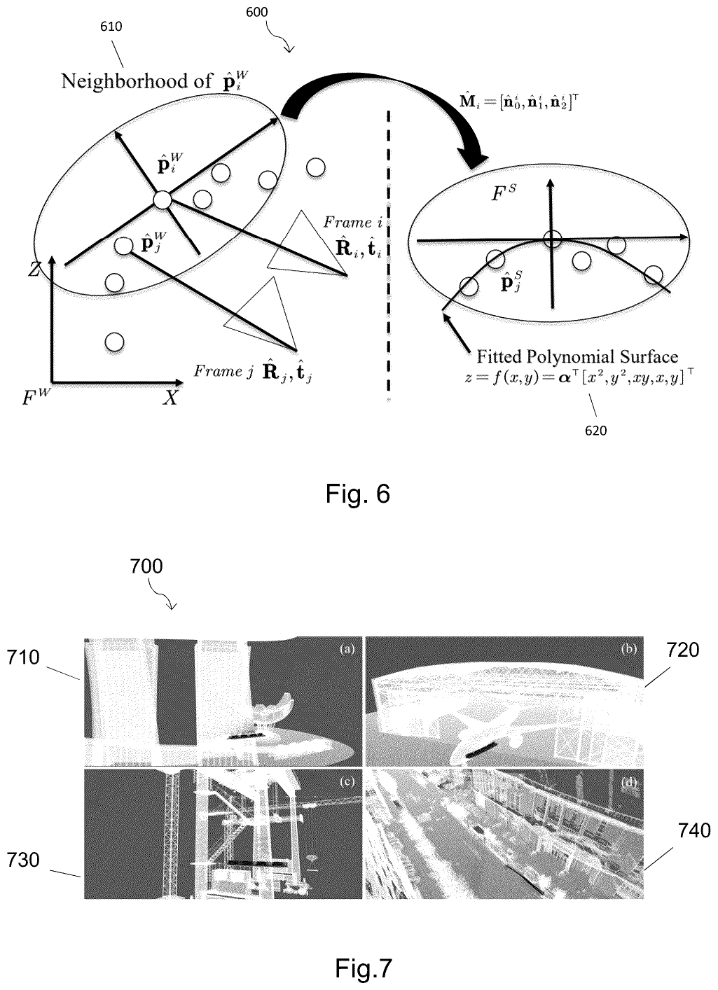

is the matrix that transform the points from F^{W} to F^{S} as shown in FIG. 6.

FIG. 6 illustrates an example of surface fitting within a smoothing kernel 600. The example shows the projection of neighbourhood points 610 from F^{W} to F^{S} and the fitted polynomial surface 620 for the points.

2) Weighted Surface Fitting: For the smoothing kernel

$${\hat{p}}_{i}^{W} ,$$

its neighborhood points

$$\{ {\hat{p}}_{j}^{W} , j ∈ {Φ}_{i} \}$$

may be projected to smoothing kernel's tangent space F^{S}:

$${[ {\hat{x}}_{j}^{S} , {\hat{y}}_{j}^{S} , {\hat{z}}_{j}^{S} ]}^{T} = {\hat{p}}_{j}^{S} = {\hat{M}}_{i} ( {\hat{p}}_{j}^{W} - {\hat{p}}_{i}^{W} ) . \qquad ( 7 )$$

Letting the parameters for the smoothing kernel

$${\hat{p}}_{i}^{W}$$

be

$${α}^{i} = {[ {α}_{0}^{i} , {α}_{1}^{i} , … , {α}_{5}^{i} ]}^{T}$$

the smoothed coordinates of

$${\hat{p}}_{j}^{S}$$

is

$${[ {\hat{x}}_{j}^{S} , {\hat{y}}_{j}^{S} , {f}_{i} ( {\hat{x}}_{j}^{S} , {\hat{y}}_{j}^{S} ) ]}^{T} ,$$

where

$${f}_{i} ( {\hat{x}}_{j}^{S} , {\hat{y}}_{j}^{S} )$$

is the polynomial function are calculated as follows:

$${f}_{i} ( {\hat{x}}_{j}^{S} , {\hat{y}}_{j}^{S} ) = {{α}^{{i}^{T}} [ {( {\hat{x}}_{j}^{S} )}^{2} , {( {\hat{y}}_{j}^{S} )}^{2} , {\hat{x}}_{j}^{S} , {\hat{y}}_{j}^{S} , {\hat{y}}_{j}^{S} ]}^{T} . \qquad ( 8 )$$

A problem may be to robustly determine the optimal parameter αⁱ using the projected noisy points

$$\{ {\hat{p}}_{j}^{S} , j ∈ {Φ}_{i} \} .$$

Example embodiments may find the optimal parameters αⁱ using least-square estimation considering the Gaussian radial weight function w(d):

$${arg min}_{{α}^{i}} {\sum }_{j ∈ {Φ}_{i}} {\vert ( {f}_{i} ( {\hat{x}}_{j}^{S} , {\hat{y}}_{j}^{S} ) - {\hat{z}}_{j}^{S} ) w ( \vert {\hat{p}}_{j}^{S} \vert ) \vert}^{2} , \\ w ( d ) = {e}^{- {d}^{2} / {γ}^{2}} , \qquad ( 9 )$$

Then the fitted polynomial surface may be obtained as shown in FIG. 6.

3) Points Smoothing and Factor Association: By replacing

$${\hat{z}}_{j}^{S}$$

with

$${f}_{i} ( {\hat{x}}_{j}^{S} , {\hat{y}}_{j}^{S} )$$

for each point in

$$\{ {\hat{p}}_{j}^{S} , j ∈ {Φ}_{i} \} ,$$

example embodiments can obtain the smoothed point clouds. Moreover, the difference between

$${\hat{z}}_{j}^{S}$$

and

$${f}_{i} ( {\hat{x}}_{j}^{S} , {\hat{y}}_{j}^{S} )$$

may be regarded as the error caused by the poses' error. Therefore, example embodiments may associate

$$\{ {\hat{p}}_{j}^{S} , j ∈ {Φ}_{i} \}$$

with

$${\hat{p}}_{i}^{S} ,$$

and use it for the following poses adjustment if the proposed PSS-BA still has not converged.

### C. Poses Adjustment Using Polynomial Surface Constraints

1) Jacobian calculation of polynomial residual: The difference between

$${\hat{z}}_{j}^{S}$$

and the fitted polynomial surface

$${f}_{i} ( {\hat{x}}_{j}^{S} , {\hat{y}}_{j}^{S} )$$

may be regarded as the error σ_{i,j} and written as follow:

$${σ}_{i , j} = {f}_{i} ( {\hat{x}}_{j}^{S} , {\hat{y}}_{j}^{S} ) - {\hat{z}}_{j}^{S} \qquad ( 10 )$$

σ_{i,j} is correlated with i^{th} and j^{th} poses, namely [\hat{R}ⱼ, \hat{t}ⱼ] and as shown in FIG. 6. The Jacobian of σ_{i,j} with respect to the i^{th} pose can be derived using the chain rule as follows:

$$\begin{matrix}\frac{\partial {σ}_{i , j}}{\partial {\hat{t}}_{i}} = \frac{\partial {σ}_{i , j}}{\partial {\hat{p}}_{j}^{S}} \frac{\partial {\hat{p}}_{j}^{S}}{\partial {\hat{p}}_{i}^{W}} \frac{\partial {\hat{p}}_{i}^{W}}{\partial {\hat{t}}_{i}} = - \frac{\partial {σ}_{i , j}}{\partial {\hat{p}}_{i}^{S}} {\hat{M}}_{i} , \\ \frac{\partial {σ}_{i , j}}{\partial {\hat{θ}}_{i}} = \frac{\partial {σ}_{i , j}}{\partial {\hat{p}}_{j}^{S}} \frac{\partial {\hat{p}}_{j}^{S}}{\partial {\hat{p}}_{i}^{W}} \frac{\partial {\hat{p}}_{i}^{W}}{\partial {\hat{θ}}_{i}} = - \frac{\partial {σ}_{i , j}}{\partial {\hat{p}}_{i}^{S}} {{\hat{M}}_{i} [ {\hat{R}}_{i} {p}_{i}^{L} ]}_{\times } , \\ \frac{\partial {σ}_{i , j}}{\partial {\hat{p}}_{j}^{S}} = [ 2 {α}_{0}^{i} {\hat{x}}_{j}^{S} + {α}_{2}^{i} {\hat{y}}_{j}^{S} + {α}_{3}^{i} , {α}_{1}^{i} {\hat{y}}_{j}^{S} + {α}_{2}^{i} {\hat{x}}_{j}^{S} + {α}_{4}^{i} , - 1 ] .\end{matrix} \qquad ( 11 )$$

Similarly, the Jacobian of σ_{i,j} respect with the j^{th} pose is as follows:

$$\begin{matrix}\frac{\partial {σ}_{i , j}}{\partial {\hat{t}}_{i}} = \frac{\partial {σ}_{i , j}}{\partial {\hat{p}}_{j}^{S}} \frac{\partial {\hat{p}}_{j}^{S}}{\partial {\hat{p}}_{j}^{W}} \frac{\partial {\hat{p}}_{j}^{W}}{\partial {\hat{t}}_{j}} = - \frac{\partial {σ}_{i , j}}{\partial {\hat{p}}_{j}^{S}} {\hat{M}}_{i} , \\ \frac{\partial {σ}_{i , j}}{\partial {\hat{θ}}_{j}} = \frac{\partial {σ}_{i , j}}{\partial {\hat{p}}_{j}^{S}} \frac{\partial {\hat{p}}_{j}^{S}}{\partial {\hat{p}}_{j}^{W}} \frac{\partial {\hat{p}}_{j}^{W}}{\partial {\hat{θ}}_{j}} = - \frac{\partial {σ}_{i , j}}{\partial {\hat{p}}_{j}^{S}} {{\hat{M}}_{i} [ {\hat{R}}_{j} {p}_{j}^{L} ]}_{\times } .\end{matrix} \qquad ( 12 )$$

2) Poses correction: Finally, example embodiments may combine all the polynomial residuals to correct the poses using least-square estimation as follows:

$${arg min}_{\dot{X}} {\sum }_{i ∈ ψ} {\sum }_{j ∈ {Φ}_{i}} {\vert {σ}_{i , j} \vert}^{2} . \qquad ( 13 )$$

If the change of the norm for \hat{X} after optimization is smaller than a threshold T_{conv}, the proposed example embodiments as disclosed herein, e.g. PSS-BA may be terminated, and a smoothed point cloud may be output. Otherwise, in example embodiments, e.g. PSS-BA, systems and methods as disclosed herein may decrease the kernel size and continue the next iteration as outlined herein.

### Experiments

### A. Example Implementation

Example embodiments of the systems and methods as disclosed herein (e.g. PSS-BA) may be implemented in C++. The initial kernel size γ may be set to 3 m. The decreasing factor k may be set to 1.4. The balance factor μ for L₀ optimization of normal may be set to 0.05. The termination threshold T_{conv} may be set to 0.01. The size of the total frames to be optimized may be limited to 100 in this example, considering the high memory usage of LiDAR BA algorithms. All algorithms in this experimental example set are evaluated on a computer with an Intel Core 19-12900 CPU.

### B. Simulation Dataset

To evaluate the proposed systems and methods as disclosed herein, example embodiments may first simulate the laser scanning frames using MARSIM in various environments as shown in FIG. 7.

FIG. 7 illustrates an example of simulation of UAV LiDAR sensing in complex environments using MARSIM 700. The dark points belong to the current LiDAR frame. The white points are the ground truth point clouds. The axis sequences are the simulated trajectories of the UAV. The simulation is provided for scenarios of Singapore Marina Bay Sands (MBS) 710, Hangar 720, Crane 730 and Street 740.

The laser sensor used for simulation may be a low-cost LiDAR, for example Livox Mid360, which may be widely used for 3D mapping. The first three ground truth point clouds may be provided by the CARIC benchmark, which mainly focuses on inspection applications with irregular shapes and 3D curves. In this example embodiment the last ground truth point clouds with 3-centimeter accuracy were collected using a mobile mapping system in the urban environment. The UAV trajectories for simulation were pre-defined manually. Then the simulated laser scanning data are split into groups with 100 sequential frames. In this example embodiment Gaussian noises were added to the ground truth poses (0.2 m and 1 deg for translation and rotation, respectively) to simulate initial inaccurate values, which are used as the input for different LiDAR BA algorithms.

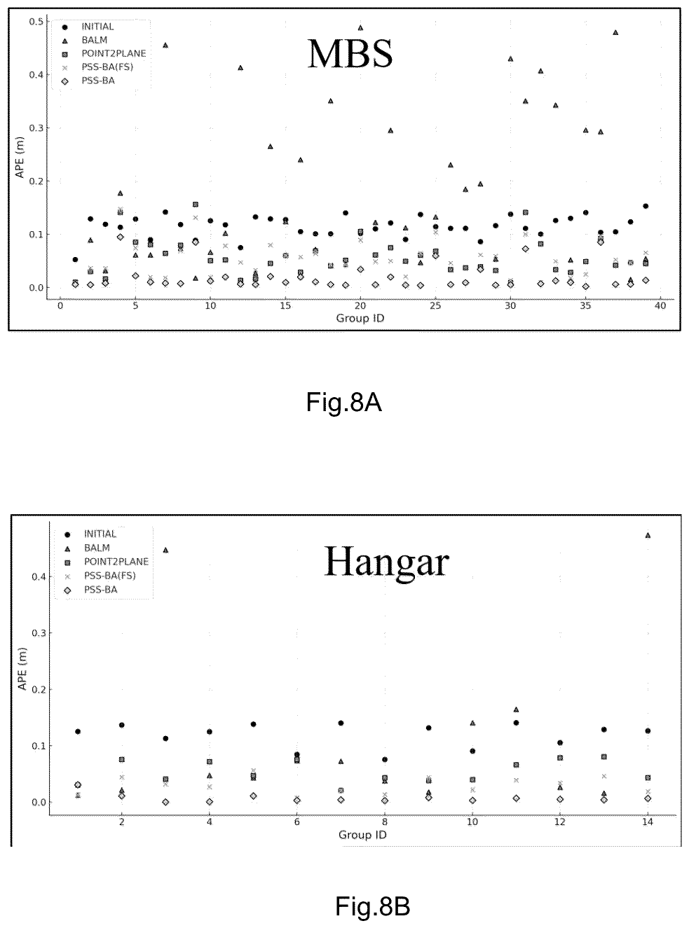

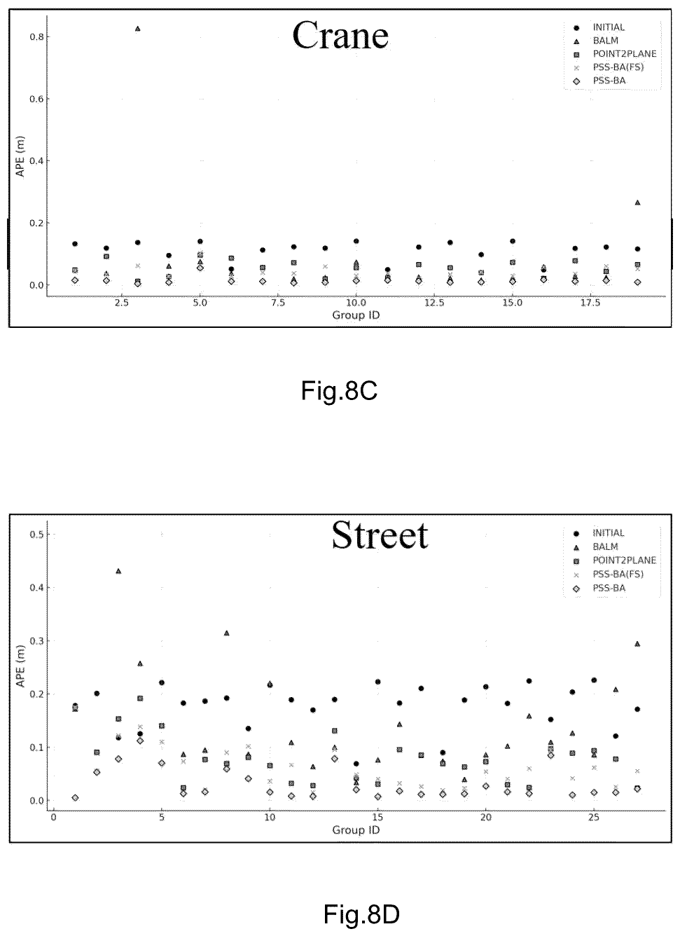

The SOTA method, BALM, which utilizes planar voxel as the adjustment constraints is compared. Furthermore, example embodiments include a modified PSS-BA by: (1) using only the point-to-plane constraints (Point2Plane); (2) using only a fixed scale without changing the smoothing kernel width γ (PSSBA [FS]) as the ablation. Absolute Position Error (APE) may be used to evaluate the accuracies of different methods as plotted in FIG. 8A-8D.

FIG. 8A illustrates results of an evaluation of different methods on a simulation dataset for Singapore Marina Bay Sands (MBS). PSS-BA is shown to have the lowest APE and therefore the best accuracy among the methods evaluated.

FIG. 8B illustrates results of an evaluation of different methods on a simulation dataset for Hangar. PSS-BA is shown to have the lowest APE and therefore the best accuracy among the methods evaluated.

FIG. 8C illustrates results of an evaluation of different methods on a simulation dataset for Crane. PSS-BA is shown to have the lowest APE and therefore the best accuracy among the methods evaluated.

FIG. 8D illustrates results of an evaluation of different methods on a simulation dataset for Street. PSS-BA is shown to have the lowest APE and therefore the best accuracy among the methods evaluated.

It is found that BALM sometimes diverges because it cannot get enough constraints in the environments without enough planar features. The average APE is listed in Table I. The divergence cases are removed to get meaningful statistics for BALM. Table I demonstrates that the example embodiments disclosed herein, e.g. the proposed PSS-BA outperforms other methods in the simulation datasets.

Table I below shows the ATE of PSS-BA and other methods on simulation dataset (Unit [m]). The best results are in bold under the “PSS-BA” column, second best results are in underlined under the “PSS-BA (FS)” column.

| Dataset | Initial | BALM | Point2Plane | PSS-BA (FS) | PSS-BA |
|---|---|---|---|---|---|
| MBS | 0.11 | 0.09 | 0.05 | 0.05 | 0.02 |
| Hangar | 0.12 | 0.07 | 0.06 | 0.03 | 0.01 |
| Crane | 0.11 | 0.07 | 0.06 | 0.04 | 0.01 |
| Street | 0.17 | 0.09 | 0.08 | 0.06 | 0.03 |

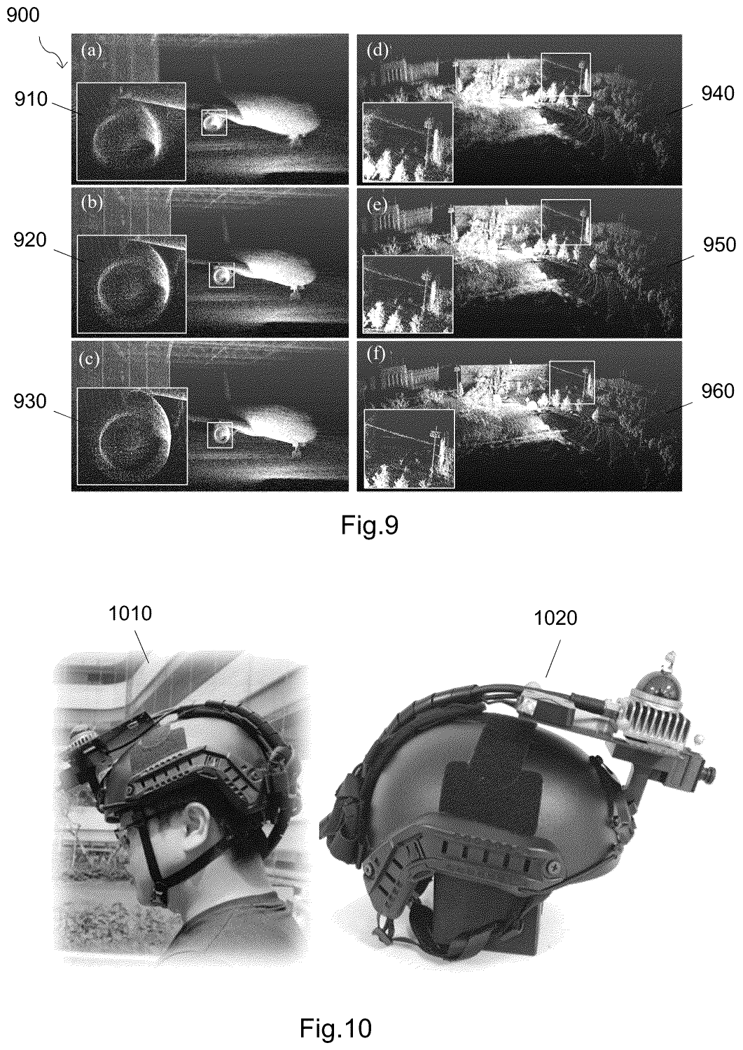

Unlike the Point2Plane strategy, which depends solely on planar features, example embodiments disclosed herein, e.g. the proposed PSS-BA may yield superior results in environments with a lot of 3D curvatures. The polynomial surface residual used in the example embodiments disclosed herein, e.g. the PSS-BA may be more accurate than the local planar assumption for the complex environments. Furthermore, when compared with PSS-BA (FS), the progressive smoothing strategy of example embodiments disclosed herein may offer improved outcomes by effectively balancing convergence and precision. Some visual comparisons of the resulting point clouds are illustrated in FIG. 9, which demonstrates that example embodiments disclosed herein, e.g. the proposed PSS-BA, could obtain sharp and accurate point clouds for the complex 3D shapes.

FIG. 9 illustrates a visual comparison 900 of results of different methods as described herein. Results 910, 920 and 930 are the results from initial values, BALM and PSS-BA on the hangar dataset, respectively. Results 940, 950, 960 are the results from initial values, BALM and PSS-BA on the street dataset, respectively.

### C. Real-World Dataset

In an example embodiment, in-house collected datasets are utilised, collected using a helmet-based mapping system consisting of a Livox Mid360 laser scanner (FIG. 10) in the Nanyang Technological University (NTU) campus.

FIG. 10 illustrates an example embodiment of a mapping system which comprises an in-house helmet based mapping system. The helmet based mapping system 1020 can be worn by a user 1010.

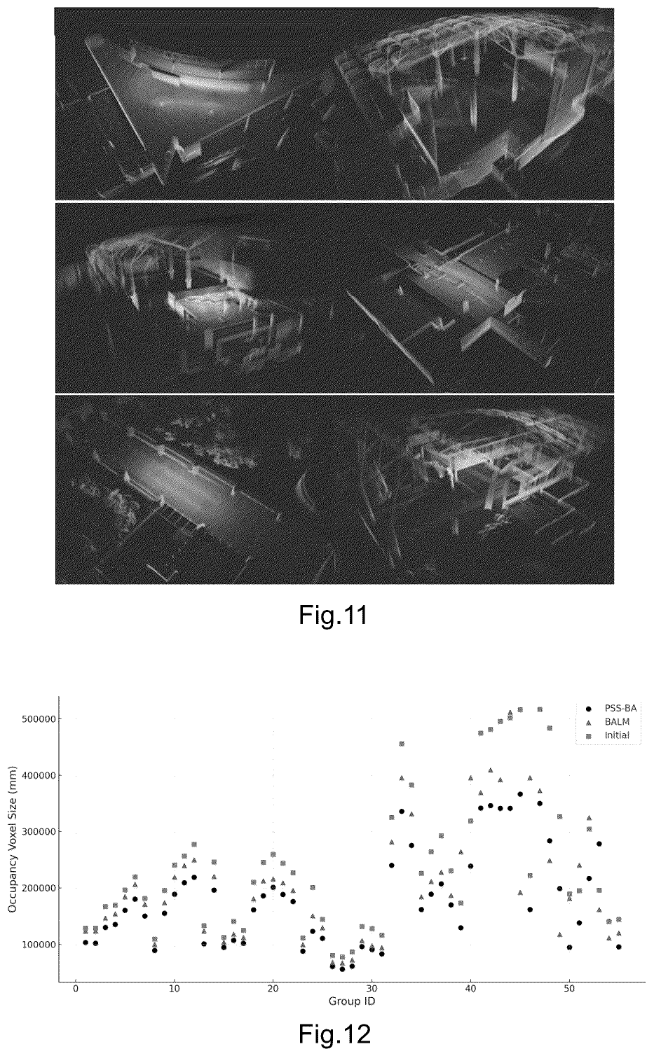

The initial values for the bundle adjustment are also obtained using Fast-LIO. The laser scanning data are split into groups with 100 sequential frames. Some sample results from the example embodiments disclosed herein, e.g. the proposed PSS-BA are shown in FIG. 11.

FIG. 11 illustrates an example of sample point clouds resulting from PSS-BA in the Nanyang Technological University (NTU) campus.

From the visual inspection, the resulting point clouds from the proposed PSS-BA appear to be very sharp and clear, even the indoor environments with irregular and complex 3D shapes, which may cause difficulty for the plane-based bundle adjustment methods.

To evaluate the mapping accuracies, an experimental example adopted the method proposed by and commonly used for point cloud accuracies without ground truth. The evaluation criteria are intuitive, and count the occupancy of resulting point clouds. If the point clouds are registered with each other very well, they should occupy less voxels. Based on this assumption, the experiment divided the 3D space into voxels with the size of 0.1 m, then counted the voxels occupied and plotted in FIG. 12.

FIG. 12 illustrates results of an evaluation of different methods on a real dataset. The average occupancy voxel sizes for initial values, BALM, and PSS-BA are 24717, 203940 and 176480, respectively. PSS-BA is shown to have a relatively low average occupancy voxel sizes.

As the Fast-LIO provided good initial poses, the occupancy voxel sizes are not improved in some groups of the real-world datasets using the LiDAR bundle adjustment. However, as the operator moved aggressively in the rest of the groups, the Fast-LIO may suffer from drifts. The example embodiments disclosed herein, e.g. the proposed methods and systems, could achieve better accuracies than the BALM, which only relies on planar features. Overall, the average occupancy voxel sizes for initial values, BALM, and PSS-BA are 241717, 203940, and 176480, respectively. The statistics indicate that the example embodiments disclosed herein, e.g. the proposed PSS-BA could achieve the best mapping accuracies in complex indoor environments.

Example embodiments disclosed herein propose various methods and systems, including the proposed PSS-BA, targeting the accurate construction of point clouds from LIDAR data in complex environments. Existing solutions predominantly depend on detecting planar features, which may be inadequate in complex environments with less structural geometry or substantial initial pose errors.

The example embodiments disclosed herein, e.g. PSS-BA, overcomes these challenges by combining spatial smoothing and poses adjustment modules, ensuring local consistency and global accuracy, which may lead to precise poses and high-quality point cloud reconstruction. For the example embodiments disclosed herein, e.g. PSS-BA, effectiveness has been demonstrated in simulation and real-world datasets, offering a promising solution for accurate 3D modelling in challenging environments.

Due to memory limitation, example embodiments disclosed herein, e.g. PSS-BA, may only be able to process several hundred frames together, which may limit the PSS-BA's application on large-scale mapping applications. In example embodiments, this may be improved to large-scale applications by utilising hierarchical adjustment strategies.

### APPENDIX FOR AUXILIARY OPTIMIZATION

To minimize Eq. (5), example embodiments used the auxiliary function Ξ introduced by:

$${arg min}_{\hat{n} , \vert \hat{n} \vert = 1 , Ξ} G ( {\hat{n}}_{i} ) = 1 - {\hat{n}}_{i}^{⊤} {\breve{n}}_{i} + β {\vert D ( {\hat{n}}_{i} ) - Ξ \vert}^{2} + μ {\vert Ξ \vert}_{0} , \qquad ( 14 )$$

where the β controls how quickly the auxiliary function Ξ approaches Eq. (5), and is set to 0.01 at the beginning. With an initial guess of \hat{n}, the above equation is optimized by fixing Ξ as follow:

$${arg min}_{Ξ} G ( {\hat{n}}_{i} ) = β {\vert D ( {\hat{n}}_{i} ) - Ξ \vert}^{2} + μ {\vert Ξ \vert}_{0} , \qquad ( 15 )$$

The solution of Eq. (15) is given by:

$$\{ \begin{matrix}{Ξ}_{j} = 0 , \frac{μ}{β} > {\vert {D ( {\hat{n}}_{i} )}_{j} \vert}^{2} \\ {Ξ}_{j} = {D ( {\hat{n}}_{i} )}_{j} , otherwise .\end{matrix} \qquad ( 16 )$$

Next, Ξ is fixed to optimize the normal \hat{n} as follow:

$${arg min}_{\hat{n} , \vert \hat{n} \vert = 1} G ( {\hat{n}}_{i} ) = 1 - {\hat{n}}_{i}^{⊤} {\breve{n}}_{i} + β {\vert D ( {\hat{n}}_{i} ) - Ξ \vert}^{2} . \qquad ( 17 )$$

Eq. 17 is quadratic and can be optimized using least square estimation. It should be noted that as |\hat{n}|=1, \hat{n} is updated using Eq. (3). The optimization of Eq. (15) and Eq. (17) iteratively with β←2β to make Ξ approach D(\hat{n}ᵢ).

Whilst the foregoing description has described exemplary embodiments, it will be understood by those skilled in the art that many variations of the embodiments can be made within the scope and spirit of the present invention.

1. A system for LiDAR point cloud processing, comprising:
a point cloud data acquisition module configured to receive point cloud data;
a spatial smoothing module configured to generate a fitted surface from the point cloud data using a predetermined kernel size, wherein the fitted surface provides an estimation of locations of points in the point cloud data;
a pose adjustment module configured to perform pose adjustment on a LIDAR frame of the point cloud data by calculating an error between points on the fitted surface and corresponding data points in the point cloud data, and adjusting a pose of the LiDAR frame to minimize the error; and
a convergence determination module configured to assess a convergence of the pose adjustment by comparing a change in pose adjustment to a threshold value, wherein if the change exceeds the threshold value, the kernel size is updated, and the system is configured to repeat the spatial smoothing and pose adjustment modules with the updated kernel size.

2. The system according to claim 1, wherein the spatial smoothing module is further configured to sample the point cloud data using Principal Component Analysis (PCA) to calculate an initial point normal of the point cloud data.

3. The system according to claim 1, wherein the spatial smoothing module is further configured to obtain an estimation of initial point normals in relation to neighborhood point normals, wherein neighborhood points are located within a distance defined by the kernel size from the initial points.

4. The system according to claim 3, wherein the spatial smoothing module is further configured to project neighborhood points to a tangent space of a kernel.

5. The system according to claim 4, wherein the spatial smoothing module is further configured to determine parameters for a kernel using the projected neighborhood points.

6. The system according to claim 1, wherein the spatial smoothing module is further configured to determine optimal parameters for a polynomial smoothing kernel using least squares estimation, wherein the estimation is based on a Gaussian radial weight function.

7. The system according to claim 1, wherein the pose adjustment module is further configured to determine a Jacobian of the error.

8. The system of claim 1, wherein the convergence determination module is configured to update the kernel size by reducing the kernel size.

9. The system of claim 1, wherein the convergence determination module is configured to update the kernel size by reducing the kernel size in steps according to a predefined reduction factor or a reduction function.

10. The system of claim 1, wherein the convergence determination module is configured to update the kernel size with a constant.

11. A method for LiDAR point cloud processing, comprising:
receiving point cloud data;
generating a fitted surface from the point cloud data using a predetermined kernel size, wherein the fitted surface provides an estimation of locations of points in the point cloud data;
performing pose adjustment on a LiDAR frame of the point cloud data by calculating an error between points on the fitted surface and corresponding data points in the point cloud data, and adjusting a pose of the LiDAR frame to minimize the error;
assessing a convergence of the pose adjustment by comparing a change in pose adjustment to a threshold value; and
when the change exceeds the threshold value, updating the kernel size and re-iterating the fitted surface generation and pose adjustment steps with the updated kernel size.

12. The method according to claim 11, wherein the step of generating the fitted surface further comprises sampling the point cloud data using Principal Component Analysis (PCA) to calculate an initial point normal of the point cloud data.

13. The method according to claim 11, wherein the step of generating the fitted surface further comprises obtaining an estimation of initial point normals in relation to neighborhood point normals, wherein neighborhood points are located within a distance defined by the kernel size from the initial points.

14. The method according to claim 13, wherein the step of generating the fitted surface further comprises projecting neighborhood points to a tangent space of a kernel.

15. The method according to claim 14, wherein the step of generating the fitted surface further comprises determining parameters for a kernel using the projected neighborhood points.

16. The method according to claim 11, wherein the step of generating the fitted surface further comprises determining optimal parameters for a polynomial smoothing kernel using least squares estimation, wherein the estimation is based on a Gaussian radial weight function.

17. The method according to claim 11, wherein the step of performing pose adjustment further comprises determining a Jacobian of the error between points on the fitted surface and corresponding data points in the point cloud data.

18. The method according to claim 11, wherein the step of assessing convergence of the pose adjustment further comprises updating the kernel size by reducing the kernel size.

19. The method according to claim 11, wherein the step of assessing convergence of the pose adjustment further comprises updating the kernel size by reducing the kernel size in steps according to a predefined reduction factor or a reduction function.

20. The method according to claim 11, wherein the step of assessing convergence of the pose adjustment further comprises updating the kernel size with a constant.
